(19) United States
(12) Patent Application Publication
(10) Pub. No.: US 2024/0375279 A1
(43) Pub. Date: Nov. 14, 2024

(54) DEVICE AND METHOD FOR CONTROLLING A ROBOT DEVICE

(71) Applicant: dConstruct Technologies Pte. Ltd., Singapore (SG)

(72) Inventors: Zhen Ling TSAI, Singapore (SG); Jia Yi CHONG, Singapore (SG); Krittin KAWKEEREE, Singapore (SG); Sherly -, Singapore (SG)

(21) Appl. No.: 18/692,372

(22) PCT Filed: Sep. 17, 2021
(86) PCT No.: PCT/SG2021/050569

§ 371 Date: Mar. 15, 2024

(51) Int. Cl. B25J 9/16; G06N 3/0455; G06N 3/08

(52) U.S. Cl. CPC B25J 9/1664; B25J 9/163; B25J 9/1697; G06N 3/0455; G06N 3/08

(57) ABSTRACT

A method for training a robot device controller is described comprising training a neural network comprising an encoder network, a decoder network and a policy network, such that, for each of a plurality of digital training input images, the encoder network encodes the digital training input image to a feature in a latent space, the decoder network determines, from the feature, for each of a plurality of areas shown in the digital training input image, whether the area is traversable and information about the distance between the viewpoint of the digital training input image and the area and the policy model determines, from the feature, control information for controlling movement of a robot device wherein at least the policy model is trained in a supervised manner using control information ground truth data of the digital training input images.

### CROSS-REFERENCE TO RELATED APPLICATIONS

This application is a national stage entry according to 35 U.S.C. 371 of PCT Application No. PCT/SG2021/050569 filed on Sep. 17, 2021, which is entirely incorporated herein by reference.

### TECHNICAL FIELD

Various aspects of this disclosure relate to devices and methods for controlling a robot device and devices and methods for training a robot device controller.

### BACKGROUND

Robot devices such as mobile robots may be controlled using remote control by a human user. For this, the human user may be for example supplied with images from the robot's point of view and react accordingly, e.g. maneuver the robot around obstacles. However, this requires precise inputs by the user at correct times and thus requires constant attention from the human user.

Accordingly, approaches are desirable allowing a robot to move more autonomously, e.g. following high-level commands of a human user such as “move forward” (along a path such as a corridor), “turn right” or “turn left”.

### SUMMARY

According to various embodiments, a method for training a robot device controller is provided including training a neural network including an encoder network, a decoder network and a policy network, such that, for each of a plurality of digital training input images, the encoder network encodes the digital training input image to a feature in a latent space, the decoder network determines, from the feature, for each of a plurality of areas shown in the digital training input image, whether the area is traversable and information about the distance between the viewpoint of the digital training input image and the area and the policy model determines, from the feature, control information for controlling movement of a robot device, wherein at least the policy model is trained in a supervised manner using control information ground truth data of the digital training input images.

According to one embodiment, training the encoder network and the decoder network includes training an autoencoder including the encoder network and the decoder network.

According to one embodiment, the method includes training the encoder network jointly with the decoder network.

According to one embodiment, the method includes training the encoder network jointly with the decoder network and the policy network.

According to one embodiment, the decoder network includes a semantic decoder and a depth decoder and wherein the neural network is trained such that, for each digital training input image, the semantic decoder determines, from the feature, for each of a plurality of areas shown in the digital training input image, whether the area is traversable and the depth decoder determines, from the one or more features, for each of a plurality of areas shown in the digital training input image, information about the distance between the viewpoint of the digital training input image and the area.

According to one embodiment, the semantic decoder is trained in a supervised manner.

According to one embodiment, the depth decoder is trained in a supervised manner or wherein the depth decoder is trained in an unsupervised manner.

According to one embodiment, one or more of the encoder network, the decoder network and the policy network are convolutional neural networks.

According to one embodiment, the control information includes control information for each of a plurality of robot device movement commands.

According to one embodiment, the neural network is trained such that the policy model determines the control information from features to which the encoder has encoded a plurality of training input images.

According to one embodiment, a method for controlling a robot device is provided including training a robot device controller according to the method according to any one of the embodiments described above, obtaining one or more digital images showing surroundings of the robot device, encoding the one or more digital images to one or more features using the encoder network, supplying the one or more features to the policy network; and controlling the robot according to control information output of the policy model in response to the one or more features.

According to one embodiment, the method includes receiving the one or more digital images from one or more cameras of the robotic device.

According to one embodiment, the control information includes control information for each of a plurality of robot device movement commands and wherein the method includes receiving an indication of a robot device movement command and controlling the robot according to the control information for the indicated robot device movement command.

According to one embodiment, the neural network is trained such that the policy model determines the control information from features to which the encoder has encoded a plurality of training input images and wherein the method includes obtaining a plurality of digital images showing surroundings of the robot device, encoding the plurality of digital images to a plurality of features using the encoder network, supplying the plurality of features to the policy network and controlling the robot according to control information output of the policy model in response to the plurality of features.

According to one embodiment, the plurality of digital images includes images received from different cameras.

According to one embodiment, the plurality of digital images includes images taken from different viewpoints.

According to one embodiment, the plurality of digital images includes images taken at different times.

According to one embodiment, a robot device control system is provided configured to perform the method of any one of the embodiments described above.

According to one embodiment, a computer program element is provided including program instructions, which, when executed by one or more processors, cause the one or more processors to perform the method of of any one of the embodiments described above.

According to one embodiment, a computer-readable medium is provided including program instructions, which, when executed by one or more processors, cause the one or more processors to perform the method of any one of the embodiments described above.

### BRIEF DESCRIPTION OF THE DRAWINGS

The invention will be better understood with reference to the detailed description when considered in conjunction with the non-limiting examples and the accompanying drawings, in which:

FIG. 1 shows a robot.

FIG. 2 shows a control system according to an embodiment.

FIG. 3 shows a machine learning model according to an embodiment.

FIG. 4 shows a machine learning model for processing multiple input images according to an embodiment.

FIG. 5 illustrates a method for training a robot device controller according to an embodiment.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

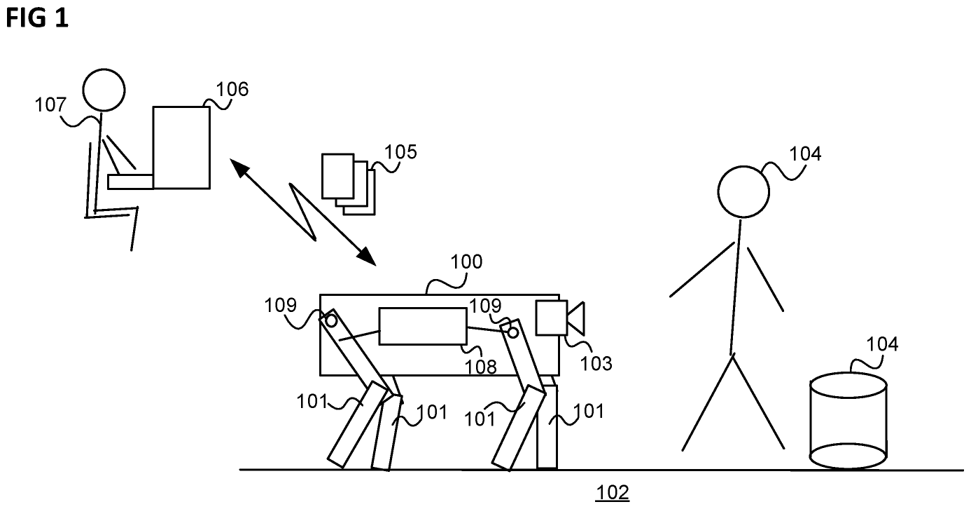

FIG. 1 shows a robot 100.

The robot 100 is a mobile device. In the example of FIG. 1, it is a quadruped robot having four legs 101 for walking on ground 102 and having a camera 103 (or multiple cameras) to observe its environment (i.e. its surroundings), in particular the ground 102 and obstacles 104 such as objects or persons.

The camera 103 for example acquires RGB images 105 (red green blue, i.e. colour images) of the robot's environment.

The images 105 may be used to control the path the robot 100 takes. This may for example happen by remote control. This means that a remote control device 106 operated by a human user 107 is provided. The human user 107 generates control commands for the robot 100 which are transmitted back to the robot 100, specifically a controller 108 of the robot, which controls movement of the robot 100 accordingly. For example, the legs include actuators 109 which the controller 108 is configured to control according to the transmitted commands.

For generating the control commands, the robot 100 may transmit the images 105 to the control device 106 which presents the images 105 (on a screen) to the human user 107. The human user 107 may then generate control commands for the robot (e.g. by means of a control device including a joystick and/or a console).

However, such a control approach requires constant engagement from the human user since the human user needs to constantly watch the RBG images delivered by the robot 100 and select corresponding control commands, e.g. to avoid the obstacles 104 and to follow a suitable path on the ground 102.

In view of the above, according to various embodiments instead of operating a robot with a control device that requires constant engagement from a human user, the human user 107 is enabled to operate the robot with simple (high-level) commands (such as “go left”, “go right”, “go forward”).

Thus, a control system according to various embodiments enables a human user (i.e. an operator, e.g. a driver) to direct a mobile device using simple instructions such as going forward, take a left, or take a right. This makes operating the device less taxing and enables the operator to perform other tasks in parallel.

According to various embodiments, the control system provides the operator with more convenient control (in particular for example a hands-free control experience) without requiring augmentations of the environment in which the robot moves such as QR codes to be deployed and without requiring prior knowledge of the route to be traversed by the robot such as a point cloud map that needs to be prepared prior operation and consumed at operation time. In particular, according to various embodiments, the control system does not require recording a robot's controls over the course of a route for later replay of the controls.

Furthermore, embodiments go beyond an intervention when the operator (human user 107) makes a mistake, such as stopping the robot 100 when an obstacle 104, e.g. a pedestrian, is too close. While this only helps to avoid collisions, various embodiments enable the human user 107 to manoeuvre the robot 100 to get from a starting point to a destination point with few simple control commands. For example, according to various embodiments, a machine learning model may be trained (by suitable labels of training data for a policy model as described below) to stop before a collision happens and make a detour.

Thus, the control system provided according to various embodiments works in any environment out of the box, without any prior knowledge of the environment or route to be taken by the robot, and has no need for deployment of fiducial markers in the environment to guide the system and has no need for a pre-recording of the route.

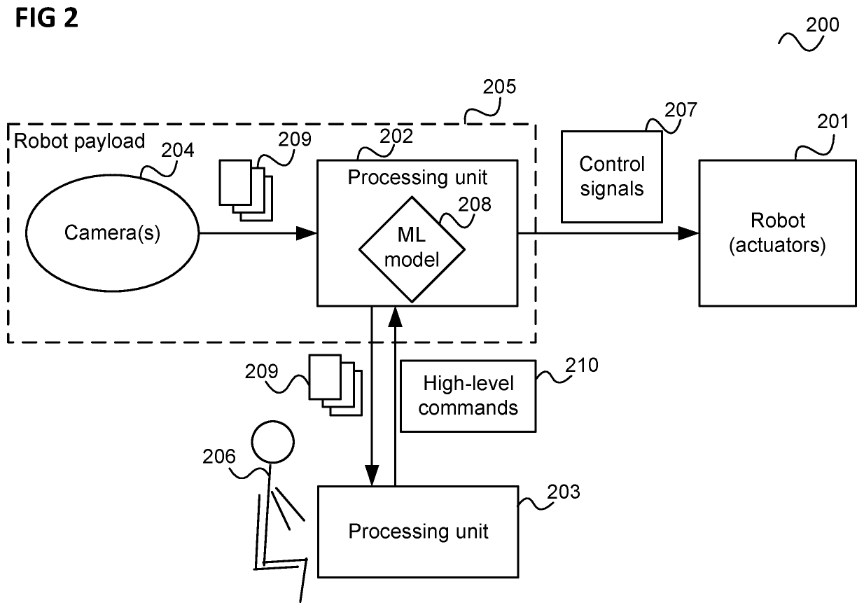

FIG. 2 shows a control system 200 according to an embodiment.

The control system 200 serves for controlling a robot 201, e.g. corresponding to the robot 100.

The control system 200 includes a first processing unit (or compute unit) 202 and a second processing unit (or compute unit) 203 as well as a camera 204 (or multiple cameras).

The camera 204 and the first processing unit 202 are part of the payload 205 of the robot 201 mounted on the robot 201. They may thus also be regarded as being part of the robot 201 and for example correspond to the camera (or cameras) 103 and the controller 108, respectively.

The second processing unit 203 for example corresponds to the remote control device 106.

As mentioned above, the control system 200 enables a human operator 206 to direct the movement of the robot 201 (generally a mobile and/or movable (robot) device) using simple instructions (i.e. high-level control commands) such as going forward, take a left turn, or take a right turn.

From these high-level control commands input by the user 206 the control system 200 automatically infers speed and angular velocity control signals 207 (e.g. for actuators 109) to manoeuvre the robot 201 accordingly.

For this, the first processing unit 202 implements a machine learning model 208. Using the machine learning model 208, the first processing unit 202 determines the control signals 207 according to the high-level control commands 210 input by the user 206. For example, if there are curves in a path (e.g. of a corridor or pathway), when the human user 206 simply inputs a forward instruction, the first processing unit 202 determines, using the machine-learning model 208, a suitable speed and angular velocity and corresponding control signals 207 to keep the robot 201 on the path (for each of a sequence of control time steps, i.e. control times).

Likewise, when the user 206 inputs a “turn left” or “turn right” instruction, the first processing unit 202 generates the control signals 207 to suit the available path, e.g. such that the robot 201 takes the turn at the right time to avoid hitting an obstacle (in particular a corridor or building wall, for example) or fall of a pathway.

The camera 204 (or cameras) is (are) for example calibrated to have good field of view of the environment.

The first processing unit 202 is in communication with the second processing unit 203 to transmit images 209 generated by the camera 209 to the second processing unit 203 and to receive the high-level commands 210 input by the user 206 into the second processing unit 203.

For this communication, the first processing unit 202 and the second processing unit 203 include communication devices which implement a corresponding wireless or wired communication interface between the processing units 202, 203 (e.g. using a cellular mobile radio network like a 5G network, WiFi, Ethernet, Bluetooth, etc.).

The camera 204 generates the images 209 for example in the form of a message stream which it provides to the first processing unit 202.

The first processing unit 202 forwards the images 209 to the second processing unit 203 which displays the images 209 to the human operator 205 to allow him to see the environment the robot is currently in. The human operator 206 uses the second processing unit 203 to issue the high-level commands 210. The second processing unit 202 transmits the high-level commands 210 to the first processing unit 202.

The first processing unit 202 hosts (implements) the machine learning model 208, is connected to the camera 204 and the components of the robot 201 to be controlled (e.g. actuators 109) and receives the high-level commands 210 from the second processing unit 203. The first processing unit 202 generate the control signals 207 by processing the images 209 and the high-level commands 210. This includes processing the images 209 using the machine learning model 208. The first processing unit 202 supplies the control signals 207 to the components of the robot 201 to be controlled.

The camera 204 is for example positioned in such a way on the robot 201 such that it provides images in first-person-view for the machine-learning model 208 for processing. The camera 204 for example provides colour images. To achieve a sufficient field of view, multiple cameras may provide the images 205.

The robot 201 provides the mechanical means to act according to the control signals. The first processing unit 202 provides the computational resources to run the machine learning model 208 fast enough for real-time inference (of the control signals 207 from the images 204 and the high-level commands). Any number of and types of cameras may be used depending on the form factor of the robot 201. The first processing unit 202 may perform stitching and calibration of the images 205 (e.g. to compensate mismatches between the cameras and camera angles and positions).

Other types of sensors than RGB cameras may be added to achieve better control performance, in particular a thermal camera, a movement sensor, a sonic transducer etc.

The first processing unit 202 determines the control signals 207 using a control algorithm which includes the processing by the machine learning model 208.

It should be noted that in one embodiment, the machine learning model 208 may also be hosted on the second processing unit 203 instead of the first processing unit 202. In that case, the determination of the control signals 207 is performed on the second processing unit 203. The control signals 207 are then transmitted by the second processing unit 203 to the first processing unit 202 (instead of the high-level commands 210) and the first processing unit forwards the control signals 207 to the robot 201.

The machine learning model 208 may also be hosted on a third processing unit arranged between the first processing unit 202 and the second processing unit 203. In this case, the determination of the control signals 207 is performed on the third processing unit, which may be in a remote location exchanging data with the first processing unit 202 and the second processing unit 203. The control system remains intact in such an arrangement as long as the second processing unit 203 receives images and sends high-level user commands in real-time. Likewise, the first processing unit 202 can send images and receive (low-level) control signals 207 in real-time.

According to various embodiments, the machine learning model 208 is a deep learning model which processes the images (i.e. frames) 209 provided by the camera 204 (or multiple cameras) into control information for the robot 201 for each control time step. According to the embodiment described in the following, the machine learning model 208 makes a prediction for the control information for all possible intentions (i.e. all possible high-level commands) for each control time step. The first processing unit 202 then determines the control signals 207 from the predicted control information according to the high-level command provided by the second processing unit 203.

The robot 201 is in this embodiment assumed to have low inertia so that it is responsive to changes in the control signals 207 at each time step.

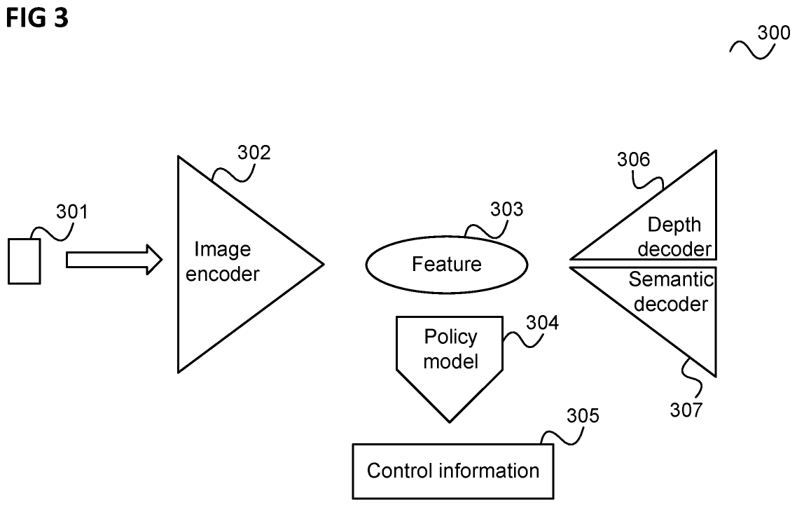

FIG. 3 shows a machine learning model 300.

In the example of FIG. 3, it is assumed that machine learning model 300 receives a single RGB (i.e. colour) input image 301, e.g. an image 301 from a single camera 204 for one control time step.

The machine learning model includes an (image) encoder 302 for converting the input image 301 to a feature 303 (i.e. a feature value or a feature vector including multiple feature values) in a feature space (i.e. a latent space). A policy model 304 generates, as output 305 of the machine learning model 300, the control information predictions.

The encoder 302 and the policy model 304 are trained (i.e. optimized) at training time and deployed for processing images during operation (i.e. at inference time).

For training, the machine learning model 300 includes a depth decoder 306 and a semantic decoder 307 (which are both not deployed or not used for inference).

The depth decoder 306 is trained to provide a depth prediction for the positions on the input image 301 (which is a training input image 301 at training time). This means that it makes a prediction of the distance of parts of the robot's environment (in particular objects) shown in the input image 301 from the robot. The output may be a dense depth prediction and may be in the form of relative depth values or absolute (scale-consistent) depth values.

The depth decoder 306 is trained to provide a semantic prediction for the positions on the input image 301 (which is a training input image 301 at training time). This means that it makes a prediction of whether parts of the robot's environment shown in the input image 301 are traversable or not.

For the encoder 302, any standard convolutional neural network (CNN) may be used. For the depth decoder 306 and the semantic decoder 307 any standard CNN may be used (provided it can be optimized for the respective use case).

The policy model 304 infers the control information (such as speed and direction (which may include one or more angles)) from the feature 303. The quality of the feature 303 matters for the policy model 304 so the encoder 302 may be trained jointly with the policy model 304. Similarly, the encoder 302 may be trained jointly with the decoders 306, 307 to ensure that the feature 303 represents depth and semantic information.

The policy model 304 is trained in a supervised manner using control information ground truth (e.g. included in labels of the training input images). For example, the policy model 304 is trained such that is reduces speed (such that the robot 201 slows down) when obstacles are close to the robot. For the forward intention (i.e. for the high-level command to go forward) it may also be trained to reduce speed when the human operator 206 needs to input an explicit instruction, i.e. in case of a symmetric Y-junction where the operator 206 needs to specify where to go forward.

Regarding angles, the forward intention is defined as path following. Thus, on a curvy path, the policy model 304 is trained to predict control information to make the robot to take turns to make sure the robot stays on the path.

For left or right intentions (i.e. high-level commands “turn left” and “turn right”), the policy model 304 is for example trained to only predict control information causing the robot to turn where it is possible, i.e. it will not make the robot turn into obstacles, but to keep moving forward, until the path is clear for a turn.

As mentioned, the policy model 304 is trained in a supervised manner, i.e. by providing a training data set including training input images, wherein for each training input image a label is provided which specifies target control information for each high-level command (i.e. ground truth control information). Mean squared error (MSE) may be used as loss for the training of the policy model 306.

The depth decoder 306 is trained such that depth prediction is geometrically accurate, e.g. such that it does not predict a triangular shaped space as a dome shaped space. The depth decoder may be trained in a supervised or unsupervised manner.

For supervised training, the label of each training input image further specifies target (ground truth) depth information that the depth decoder 306 is supposed to output. Mean squared error (MSE) may be used as loss for the training of the depth decoder 306.

For unsupervised training, for example, two cameras 204 may be used to generate images at the same time. The depth decoder 306 may then be trained to minimize the loss between an image generated by a first one of the cameras and an image reconstructed from the depth prediction for the viewpoint of the second one of the cameras. The reconstruction is done by a network which is trained to generate the image from the viewpoint of the second camera from the image taken by the first camera and from the depth information. The depth decoder can also be trained with sampled sequences in a video.

Rather than identifying the class of each pixel of the scene (which is the standard formulation for semantic segmentation) the semantic decoder 307, according to one embodiment, performs a traversable path segmentation. This means that it is trained to understand the geometry of non-convex objects such as people and chairs. In an image where a person is standing, a standard semantic segmentation model predicts the space between the person's feet as “floor” or “ground”. Instead, the semantic decoder 307 is trained to predict it as non-traversable because it is not desired that the robot 201 bumps into the person. This is the case for many furniture like chairs as well.

The semantic decoder 307 is trained in a supervised manner. For this, the label of each training input image further specifies whether parts shown in the training image are traversable or not. Cross entropy loss may be used as loss for the training of the semantic decoder 307 (e.g. with the classes “traversable” and “non-traversable”).

The encoder 302 is trained together with one or more with the other models. The encoder 302, the policy model 304, the depth decoder 306 and the semantic decoder 307 may be trained all together by summing the losses for the outputs of the policy model 304, the depth decoder 306 and the semantic decoder 307.

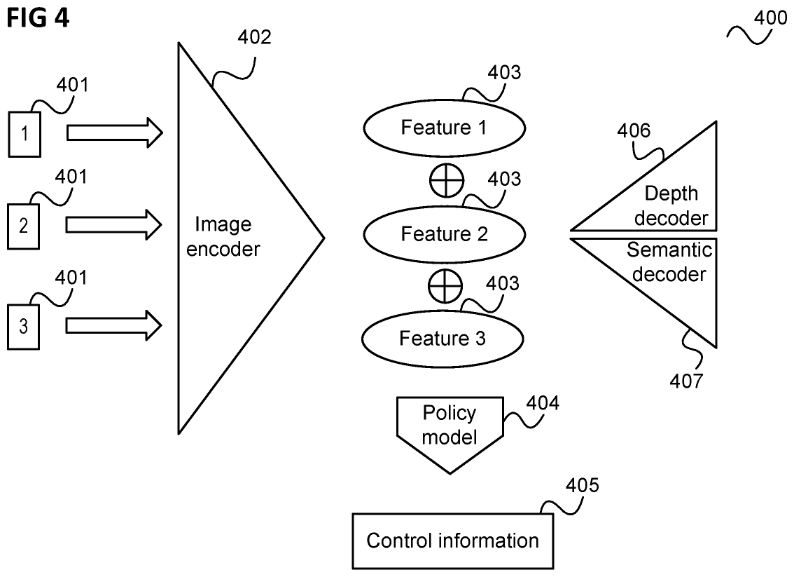

FIG. 4 shows a machine learning model 400 for processing multiple input images 401.

The machine learning model 400 may for example be applied to the case that the payload 205 includes multiple cameras 204 which each provide an image 205 for each control time step. It should be noted that the machine learning model 400 may also be used to consider multiple subsequent images 205 for predicting the control information.

All input images are supplied to the same encoder 402 (similar to the encoder 302). This results in a feature 403 for each input image.

The features 403 generated by the encoder 402 are concatenated together before being consumed by a policy model 404 to generate the control information output 405. For training, the same set of decoders (depth encoder 406 and semantic encoder 407) operates on each feature 403.

The training data may be chosen according to the use case. For example, for pedestrian-like navigation, rather than a car-like navigation, obeying traffic rules for cars is not a goal and lanes do not have to be clearly marked out.

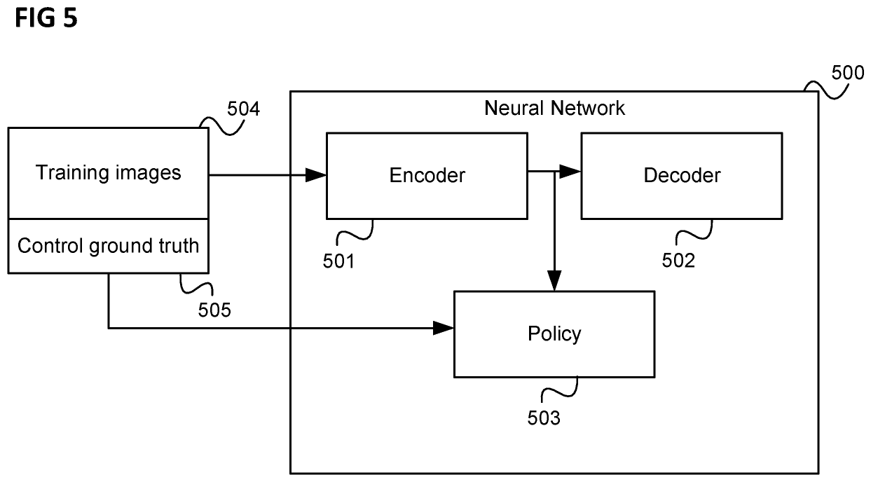

In summary, according to various embodiments, a method is provided as illustrated in FIG. 5.

FIG. 5 illustrates a method for training a robot device controller.

A neural network 500 including an encoder network 501, a decoder network 502 and a policy network 503 is trained, such that, for each of a plurality of digital training input images 504, the encoder network 501 encodes the digital training input image to a feature in a latent space, the decoder network 502 determines, from the feature, for each of a plurality of areas shown in the digital training input image, whether the area is traversable and information about the distance between the viewpoint of the digital training input image and the area and the policy model 503 determines, from the feature, control information for controlling movement of a robot device.

At least the policy model 503 is trained in a supervised manner using control information ground truth data 505 of the digital training input images 504.

According to various embodiments, in other words, a robot device is controlled based on features representing information about, for each of one or more areas, the distance of the area from the robot and whether the area is traversable for the robot device. This is achieved by training an encoder/decoder architecture wherein the decoder part reconstructs distance (i.e. depth) information and semantic information (i.e. whether an area is traversable) from features generated by the encoder and training a policy model in a supervised manner to generate control information for controlling the robot device from the features.

According to various embodiments, in other words, a method for training a robot device controller is provided including training a neural encoder network to encode one or more digital training input images to one or more features in a latent space, training a neural decoder network to determine, from the one or more features, for each of a plurality of areas shown in the one or more digital training input images, whether the area is traversable by a robot and information about the distance between the viewpoint of the one or more digital training input images were taken and the area; and training a policy model to determine, from the one or more features, control information for controlling movement of a robot device, wherein at least the policy model is trained in a supervised manner using control information ground truth data of the digital training input images;

The method of FIG. 5 is for example carried out by a robot device control system including components like a communication interface, one or more processing units, a memory (e.g. for storing the trained neural network) etc.

The approaches described above may be applied for the control of any device that is movable and/or has movable parts. This means that it may be used to control the movement of a mobile device such as a walking robot (as such in FIG. 1), a flying drone and an autonomous vehicle (e.g. for logistics) but also for controlling movement of moveable limbs of a device such as a robot arm (like an industrial robot which should, like a moving robot, for example, avoid hitting obstacles such as a passing worker) or a access control system (and thus surveillance).

Thus, the approaches described above may be used to control a movement of any physical system, like a computer-controlled machine, like a robot, a vehicle, a domestic appliance, a tool or a manufacturing machine. The term “robot device” is understood all these types of mobile devices and/or movable devices (i.e. in particular stationary devices which have movable components).

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for training a robot device controller comprising:
training a neural network comprising an encoder network, a decoder network and a policy model, such that, for each of a plurality of digital training input images,
the encoder network encodes the digital training input image to a feature in a latent space;
the decoder network determines, from the feature, for each of a plurality of areas shown in the digital training input image, whether the area is traversable and information about the distance between the viewpoint of the digital training input image and the area in the form of relative depth of the areas;
and the policy model determines, from the feature, control information for controlling movement of a robot device;
wherein at least the policy model is trained in a supervised manner using control information ground truth data of the digital training input images.

2. The method of claim 1, wherein training the encoder network and the decoder network comprises training an autoencoder comprising the encoder network and the decoder network.

3. The method of claim 1, comprising training the encoder network jointly with the decoder network.

4. The method of claim 1, comprising training the encoder network jointly with the decoder network and the policy model.

5. The method of claim 1, wherein the decoder network comprises a semantic decoder and a depth decoder and wherein the neural network is trained such that, for each digital training input image,
the semantic decoder determines, from the feature, for each of a plurality of areas shown in the digital training input image, whether the area is traversable; and
the depth decoder determines, from the one or more features, for each of a plurality of areas shown in the digital training input image,
information about the distance between the viewpoint of the digital training input image and the area.

6. The method of claim 5, wherein the semantic decoder is trained in a supervised manner.

7. The method of claim 5, wherein the depth decoder is trained in a supervised manner or wherein the depth decoder is trained in an unsupervised manner.

8. The method of claim 1, wherein one or more of the encoder network, the decoder network and the policy model are convolutional neural networks.

9. The method of claim 1, wherein the control information comprises control information for each of a plurality of robot device movement commands.

10. The method of claim 1, wherein the neural network is trained such that the policy model determines the control information from features to which the encoder has encoded a plurality of training input images.

11. A method for controlling a robot device comprising:
training a robot device controller according to claim 1;
obtaining one or more digital images showing surroundings of the robot device;
encoding the one or more digital images to one or more features using the encoder network;
supplying the one or more features to the policy model; and
controlling the robot according to control information output of the policy model in response to the one or more features.

12. The method of claim 11, comprising receiving the one or more digital images from one or more cameras of the robotic device.

13. The method of claim 11, wherein the control information comprises control information for each of a plurality of robot device movement commands and wherein the method comprises receiving an indication of a robot device movement command and controlling the robot according to the control information for the indicated robot device movement command.

14. The method of claim 11, wherein the neural network is trained such that the policy model determines the control information from features to which the encoder has encoded a plurality of training input images and wherein the method comprises obtaining a plurality of digital images showing surroundings of the robot device;
encoding the plurality of digital images to a plurality of features using the encoder network;
supplying the plurality of features to the policy model; and
controlling the robot according to control information output of the policy model in response to the plurality of features

15. The method of claim 14, wherein the plurality of digital images comprises images received from different cameras.

16. The method of claim 14, wherein the plurality of digital images comprises images taken from different viewpoints.

17. The method of claim 14, wherein the plurality of digital images comprises images taken at different times.

18. A robot device control system comprising one or more processors configured to:
train a neural network comprising an encoder network, a decoder network and a policy model, such that, for each of a plurality of digital training input images,
the encoder network encodes the digital training input image to a feature in a latent space;
the decoder network determines, from the feature, for each of a plurality of areas shown in the digital training input image, whether the area is traversable and information about the distance between the viewpoint of the digital training input image and the area in the form of relative depth of the areas;
and the policy model determines, from the feature, control information for controlling movement of a robot device;
wherein at least the policy model is trained in a supervised manner using control information ground truth data of the digital training input images.

19. (canceled)

20. A non-transitory computer-readable medium comprising program instructions, which, when executed by one or more processors, cause the one or more processors to perform the method of claim 1.
